(19) United States
(12) Patent Application Publication
(10) Pub. No.: US 2026/0161706 A1
(43) Pub. Date: Jun. 11, 2026

(54) APPARATUS AND METHOD FOR CROSS-MODAL CONTRASTIVE LEARNING TEMPORAL MOMENT LOCALIZATION

(71) Applicant: ELECTRONICS AND TELECOMMUNICATIONS RESEARCH INSTITUTE, Daejeon (KR)

(72) Inventors: JINYOUNG MOON, Daejeon (KR); MUAH SEOL, Daejeon (KR); JONGHEE KIM, Daejeon (KR)

(21) Appl. No.: 19/360,609

(22) Filed: Oct. 16, 2025

(30) Foreign Application Priority Data
Dec. 10, 2024 (KR) 10-2024-0182152

(51) Int. Cl. G06F 16/73; G06N 20/00; G06V 10/40

(52) U.S. Cl. CPC G06F 16/73; G06N 20/00; G06V 10/40

(57) ABSTRACT

The present invention relates to an apparatus and method for Cross-modal Contrastive Learning (CCL) for Temporal Moment Localization (TML). The apparatus for Cross-modal Contrastive Learning (CCL) for Temporal Moment Localization (TML) includes: an input interface device configured to receive a video and a query; a memory storing a program for performing Temporal Moment Localization (TML) to retrieve, from the video, a temporal interval corresponding to the query; and a processor configured to execute the program. The processor performs the Temporal Moment Localization (TML) by executing Cross-modal Contrastive Learning (CCL) between linguistic and visual modalities.

### BACKGROUND

### 1. Technical Field

The present invention relates to an apparatus and method for Cross-modal Contrastive Learning (CCL) for Temporal Moment Localization (TML).

### 2. Description of Related Art

Temporal Moment Localization (TML) is a task that receives an untrimmed video and a query described freely in natural language as inputs, and retrieves from the video a temporal interval consisting of a start time and an end time that best matches the query.

In conventional contrastive learning methods proposed to improve the performance of Temporal Moment Localization (TML) models, negative samples are pushed away and positive samples are pulled closer with respect to an anchor during the training process. However, this approach also pushes away negative samples that are highly similar to positive samples, thereby reducing the efficiency of representation learning. In the field of Temporal Moment Localization (TML), there may exist negative pairs that are very similar to positive pairs. As a result, when conventional contrastive learning is applied, training may not be performed properly due to the influence of such similar negative pairs.

### SUMMARY

The present invention has been proposed to solve the aforementioned problems, and its objective is to provide an apparatus and method capable of improving the performance of Temporal Moment Localization (TML), which retrieves a temporal interval corresponding to a specific moment within a video, by utilizing a deep learning-based machine learning algorithm through Cross-modal Contrastive Learning (CCL) between linguistic and visual modalities.

An apparatus for Cross-modal Contrastive Learning (CCL) for Temporal Moment Localization (TML) according to the present invention includes an input interface device configured to receive a video and a query, a memory storing a program for performing Temporal Moment Localization (TML) that retrieves a temporal interval from the video corresponding to the query, and a processor configured to execute the program. The processor performs Cross-modal Contrastive Learning (CCL) between linguistic and visual modalities in order to carry out the Temporal Moment Localization (TML).

The query is received from a user device and corresponds to a query described in natural language.

The processor performs the Cross-modal Contrastive Learning (CCL) by reducing the loss value for negative pairs that are similar to positive pairs.

The processor performs the Temporal Moment Localization (TML) by using an external modality cross-modal contrastive loss function at the video level.

Within a batch composed of video semantic segment and natural language query pairs, the processor defines the product of the similarity in the same modality as the anchor and the similarity in the opposite modality corresponding to the anchor as a negative pair margin.

The processor subtracts the negative pair margin when aggregating the loss value for negative pairs at the video level.

The processor performs the Temporal Moment Localization (TML) by using an internal modality cross-modal contrastive loss function at the frame level.

The processor performs the Temporal Moment Localization (TML) by using features extracted from video frames and sentence features corresponding to each frame, and classifying them into positive pairs within the ground truth (GT) temporal interval and negative pairs outside the GT temporal interval.

The processor defines the product of the similarity in the same modality as the anchor and the similarity in the opposite modality corresponding to the anchor, using features obtained by average pooling at the corresponding frame of the batch, as a negative pair margin.

The processor subtracts the negative pair margin when aggregating the loss value for negative pairs at the frame level.

A method for Cross-modal Contrastive Learning (CCL) for Temporal Moment Localization (TML) according to the present invention includes a step of receiving a video and a query, and performing a task of retrieving, from the video, a temporal interval corresponding to the query, and includes a step of performing Cross-modal Contrastive Learning (CCL) at both the video level and the frame level.

The step of receiving the video and the query includes receiving the query that corresponds to a query described in natural language.

The step of performing the Cross-modal Contrastive Learning (CCL) includes calculating loss values at the video level and the frame level based on the similarities between an anchor of a first modality and positive and negative pairs of a second modality different from the first modality.

The step of performing the Cross-modal Contrastive Learning (CCL) includes, at the video level, defining the product of the similarity in the same modality as the anchor and the similarity in the opposite modality corresponding to the anchor, within a batch composed of video semantic segment and natural language query pairs, as a negative pair margin.

The step of performing the Cross-modal Contrastive Learning (CCL) includes subtracting the negative pair margin when aggregating the loss value for negative pairs at the video level.

The step of performing the Cross-modal Contrastive Learning (CCL) includes, at the frame level, using features extracted from video frames and sentence features corresponding to each frame, and performing Temporal Moment Localization (TML) by classifying them into positive pairs within the ground truth (GT) temporal interval and negative pairs outside the GT temporal interval.

The step of performing the Cross-modal Contrastive Learning (CCL) includes defining the product of the similarity in the same modality as the anchor and the similarity in the opposite modality corresponding to the anchor, using features obtained by average pooling at the corresponding frame of the batch, as a negative pair margin.

The step of performing the Cross-modal Contrastive Learning (CCL) includes subtracting the negative pair margin when aggregating the loss value for negative pairs at the frame level.

According to the present invention, it is possible to improve the performance of Temporal Moment Localization (TML), which retrieves a temporal interval corresponding to a specific moment within a video, through Cross-modal Contrastive Learning (CCL).

The effects of the present invention are not limited to those mentioned above, and other effects not explicitly described herein will be clearly understood by those skilled in the art from the following description.

### BRIEF DESCRIPTION OF DRAWINGS

FIG. 1 illustrates Temporal Moment Localization (TML).

FIG. 2 illustrates a proposal feature map and a proposal confidence map in the form of a two-dimensional map.

FIG. 3 illustrates a conceptual diagram of a triplet loss function for contrastive learning.

FIG. 4 illustrates a video-level Cross-modal Contrastive Learning (CCL) method according to an embodiment of the present invention.

FIG. 5 illustrates frame-level Cross-modal Contrastive Learning (CCL) according to an embodiment of the present invention.

FIG. 6 illustrates a BMRN (Boundary Matching and Refinement Network) for Temporal Moment Localization (TML) based on boundary matching and refinement, according to an embodiment of the present invention.

FIG. 7 illustrates a comparison of Temporal Moment Localization (TML) performance on the Charades-STA dataset.

FIG. 8 illustrates a comparison of Temporal Moment Localization (TML) performance on the ActivityNet Captions dataset.

FIG. 9 illustrates the effect of using the cross-modal contrastive loss function.

FIG. 10 illustrates a comparison result with models using other contrastive loss functions.

FIG. 11 illustrates qualitative analysis results of the Temporal Moment Localization (TML) technique based on boundary refinement.

FIG. 12 is a block diagram showing a computer system for implementing the method according to an embodiment of the present invention.

### DETAILED DESCRIPTION OF THE INVENTION

The foregoing and other objects, advantages, and features of the present invention, and methods for achieving them, may be clearly understood with reference to the embodiments described in detail below in conjunction with the accompanying drawings.

However, the present invention is not limited to the embodiments disclosed below, but may be implemented in various other forms. The following embodiments are provided only to clearly convey the objectives, structure, and effects of the present invention to those skilled in the art, and the scope of the present invention shall be defined only by the claims.

Meanwhile, the terminology used in this specification is intended solely to describe embodiments and is not intended to limit the scope of the present invention. As used herein, the singular forms also include the plural forms unless the context clearly indicates otherwise. The terms “comprises” and/or “comprising” as used in the specification do not exclude the presence or addition of one or more other components, steps, operations, and/or elements not specifically mentioned.

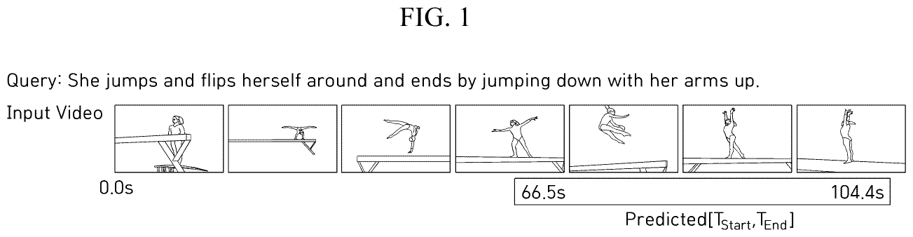

FIG. 1 illustrates Temporal Moment Localization (TML).

As shown in FIG. 1, Temporal Moment Localization (TML) is a task that receives an untrimmed video and a query described freely in natural language as inputs, and retrieves from the video a temporal interval composed of a start time and an end time that best matches the query.

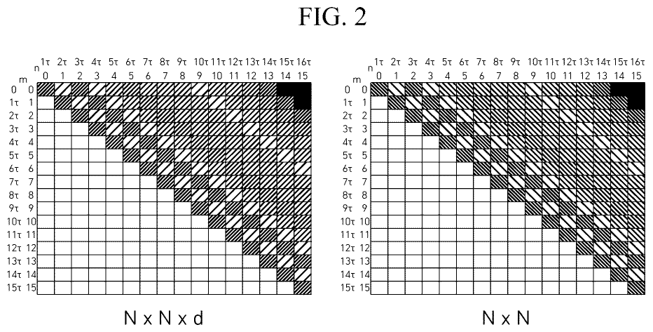

In proposal-based methods for Temporal Moment Localization (TML), without information regarding the boundaries corresponding to the start and end of the semantic segment, multiple semantic segment proposals are generated. Features for each proposal are extracted, and the confidence of each proposal is predicted based on these features. According to the prediction results, proposals whose confidence scores exceed a predefined threshold and whose overlapping regions with other proposals fall below a predefined threshold are finally returned as the result of the Temporal Moment Localization (TML). According to conventional techniques, in order to improve the accuracy of semantic segment confidence prediction with a limited number of proposals, methods have been proposed that train multiple proposals together and represent multiple proposal feature maps and confidence maps in the form of a two-dimensional map (see S. Zhang et al., “Learning 2D Temporal Adjacent Networks for Moment Localization with Natural Language,” Proc. AAAI, pp. 12870-12877, 2020). FIG. 2 illustrates a proposal feature map and a proposal confidence map in a two-dimensional format.

The row and column of the two-dimensional map respectively represent the start time and the end time of a segment. A predefined subset of proposals (e.g., the top half of the map) is used, and each cell at position (m, n) in the map corresponds to a semantic segment proposal expressed by the following Equation [1].

$$[ m \cdot τ , ( n + 1 ) \cdot τ ] , 0 \leq m \leq n \leq N - 1 \qquad [ Equation 1 ]$$

τ represents the unit length of semantic segment proposals. Based on this unit length and the number of video divisions N, the total number of semantic segments for the entire video is determined, and the total length of the video becomes τ·N.

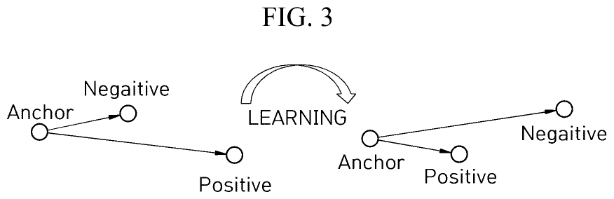

To enhance the performance of the Temporal Moment Localization (TML) model, contrastive learning is additionally introduced. FIG. 3 illustrates a conceptual diagram of the triplet loss function used for contrastive learning (see: FaceNet: A Unified Embedding for Face Recognition and Clustering, CVPR 2015, pp. 815-823). In contrastive learning, the triplet loss function is designed such that, during training, negative samples are pushed farther away from the anchor while positive samples are pulled closer. The contrastive loss function may be expressed as shown in Equation [2].

### [Equation 2]

In Equation [2], s denotes the similarity function, a denotes the anchor, p is the

$$ℒ = - log \frac{{e}^{( s ( a , p ) - m ) / τ}}{{e}^{( s ( a , p ) - m ) / τ} + {\sum }_{i = 1}^{K - 1} {e}^{s ( a , {n}_{i} ) / τ}}$$

positive sample among a total of K samples, and nᵢ (i=1, 2, . . . , K−1) denotes the K−1 negative samples. τ represents the temperature parameter (a scaling factor for the probability distribution), and m denotes the margin. The loss function is designed to make all negative samples uniformly distant from the positive sample and to increase the loss for both low-similarity positive samples and high-similarity negative samples, so that the model learns to assign high similarity to positive samples and low similarity to negative samples. However, this contrastive learning method has a limitation in that it forces even negative samples that are similar to positive samples to be pushed away, thereby reducing the efficiency of representation learning. While it may be logically correct to separate all negative samples from the anchor in tasks such as face recognition, in domains like natural language-based Temporal Moment Localization (TML) or video retrieval, language-visual pairs are classified into positive and negative pairs based on ground truth (GT), but in practice, there may exist negative pairs that are very similar to positive pairs either linguistically or visually. In such cases, when contrastive learning is applied in the above described manner, learning may fail to proceed effectively due to the influence of negative pairs that are similar to positive pairs.

The present invention has been proposed to solve the aforementioned problems and relates to an artificial intelligence system and its application for retrieving a temporal interval corresponding to a specific moment within a video by utilizing a deep learning-based machine learning algorithm. According to an embodiment of the present invention, a Cross-modal Contrastive Learning (CCL) apparatus and method between language and vision modalities are proposed to enhance performance in training a Temporal Moment Localization (TML) model. The model receives, as input, an untrimmed video and a natural language query which is written freely by a human without being constrained to a specific format and understands the content of both the video and the query. Based on this understanding, it accurately identifies a temporal interval in the video composed of a start time and an end time that most closely matches the query.

According to an embodiment of the present invention, in order to improve the performance of the Temporal Moment Localization (TML) model, Cross-modal Contrastive Learning (CCL) is performed in such a manner that not all negative pairs are treated uniformly as simply negative. Instead, the actual similarity to the positive pair is taken into account, and the loss value for negative pairs that are similar to positive pairs is reduced. This enables more robust training and allows for achieving higher accuracy in detection performance.

According to an embodiment of the present invention, a Cross-modal Contrastive Learning (CCL) apparatus and method are proposed to improve the performance of Temporal Moment Localization (TML), which aims to identify the segment within an input video that best corresponds to an input natural language query. To overcome the limitations of conventional contrastive learning, the invention defines a cross-modal loss function that takes into account the actual similarity between negative pairs and the anchor. For this purpose, both a video-level external cross-modal contrastive loss function and a frame-level internal cross-modal contrastive loss function are defined.

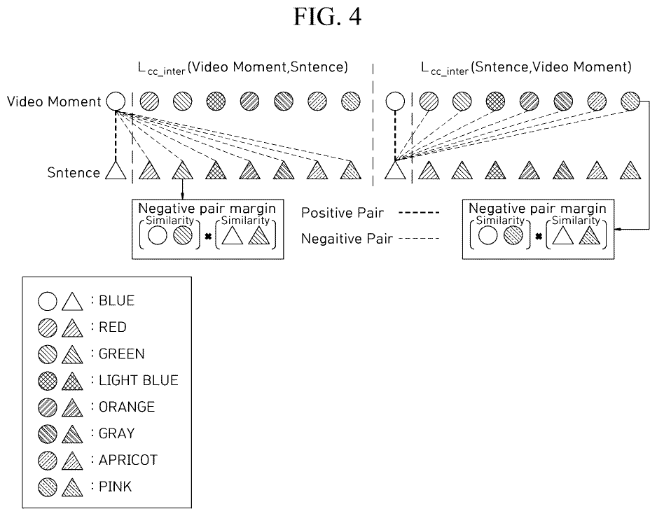

FIG. 4 illustrates a video-level Cross-modal Contrastive Learning (CCL) method according to an embodiment of the present invention. The loss function for external Cross-modal Contrastive Learning (CCL) at the video level is expressed by the following Equation [3].

$${L}_{cc \_ inter} ( a , x ) = - \frac{1}{B} {\sum }_{i = 1}^{B} log \frac{{e}^{( {a}_{i}^{T} {x}_{i} - m ) / τ}}{{e}^{( {a}_{i}^{T} {x}_{i} - m ) / τ} + {\sum }_{j \neq i}^{B} {e}^{( {a}_{i}^{T} {x}_{j} - {a}_{i}^{T} {a}_{j} \cdot {x}_{i}^{T} {x}_{j} ) / τ}} \qquad [ Equation 3 ]$$

a, x∈R^{B×d} (B denotes the batch size, and d represents the dimensionality of the features in modalities a and x.)

Let aᵢ denote the i-th anchor (where i=1, 2, . . . , batch size B), and let xⱼ denote the j-th sample in the batch. A sample whose index matches that of the anchor is classified as a positive pair sample, while a sample with a different index is classified as a negative pair sample.

In Equation [3], aᵢ is the anchor having a feature of one modality, and the pair (aᵢ, xⱼ) consists of aᵢ representing a feature in the same modality and xⱼ representing a feature in the opposite modality. T denotes the transpose operation. In the loss computation for negative pairs, aᵢ^{T}·aⱼ represents the inner product between the anchor aᵢ and aⱼ, the feature from the same modality in the negative pair. Since aᵢ and aⱼ are of equal dimension d for all samples, the inner product without scaling represents the similarity in the anchor modality.

Similarly, xᵢ^{T}·xⱼ is the inner product between xᵢ, the feature in the opposite modality corresponding to the anchor, and xⱼ, the feature in the opposite modality from the negative pair. Since xᵢ and xⱼ also have the same dimensionality across samples, the unscaled inner product indicates the similarity in the opposite modality corresponding to the anchor.

In relation to the similarity between the modality of the anchor, which is inherently included in the contrastive learning loss function, and the features of the negative pair in the corresponding modality, the video-level contrastive loss function according to an embodiment of the present invention defines the product of the similarity within the same modality as the anchor and the similarity in the corresponding modality of the anchor as a negative pair margin. As this negative pair margin increases, it indicates a higher similarity to a positive pair in the same modality. Therefore, this margin is subtracted when aggregating the loss values for negative pairs, thereby reducing the loss contribution from negative pairs that are similar to positive pairs.

Referring to FIG. 4, the left side of the diagram, with respect to the vertical dashed line in the center, illustrates the method for computing a visual-language contrastive loss function. The batch consists of K video semantic segment and natural language query pairs, and the same color represents a pair of ground-truth (GT) video semantic segment and natural language query. For contrastive learning on the visual modality of the video semantic segments, the visual feature of the blue video segment on the far left is used as the anchor. In the Cross-modal Contrastive Learning (CCL) based on conventional methods, the blue video segment's visual feature and the blue-colored natural language query among the queries at the bottom are treated as a positive pair, while the remaining queries are treated as negative pairs when computing the contrastive loss.

According to an embodiment of the present invention, in the contrastive learning for the visual modality illustrated on the left side of the diagram, at the point of comparison with the third (green) pair during the contrastive loss computation, not only is the similarity between the visual feature of the blue video semantic segment and the language feature of the green natural language query considered, but additionally: 1) the similarity between the visual feature of the blue video semantic segment and that of the green video semantic segment, and 2) the similarity between the language feature of the blue natural language query and that of the green natural language query are calculated, and 3) the product of these similarities is defined as the negative pair margin. This negative pair margin is subtracted from the cross-modal contrastive loss for negative pairs, thereby reducing the influence of negative pairs that are similar to positive pairs, compared to conventional contrastive learning methods.

Referring to the right side of FIG. 4, with respect to the central vertical dashed line, contrastive learning is performed for the language modality of the natural language query. The linguistic feature of the blue natural language query on the far left is used as the anchor. In conventional cross-modal contrastive learning, the contrastive loss is calculated by treating the pair consisting of the blue natural language query's linguistic feature and the blue video semantic segment at the top as a positive pair, while all other video semantic segments are treated as negative pairs.

When computing the contrastive loss at the comparison point involving the last (eighth) pink pair, not only is the similarity between the linguistic feature of the blue natural language query and the visual feature of the pink video semantic segment calculated, but additionally: 1) the similarity between the visual features of the blue video semantic segment and the pink video semantic segment, and 2) the similarity between the linguistic features of the blue natural language query and the pink natural language query are also computed. The product of these similarities is used to calculate the negative pair margin. This negative pair margin is subtracted from the loss function for the negative pair in the conventional cross-modal contrastive learning, thereby reducing the impact of negative pairs that are similar to positive pairs.

The foregoing has described the definition of the video-level external modality cross-modal contrastive loss function according to an embodiment of the present invention. The following describes the definition of the frame-level internal modality cross-modal contrastive loss function.

According to an embodiment of the present invention, the internal cross-modal contrastive loss function uses features extracted from individual video frames and sentence features aligned to each corresponding frame.

When the video frame feature is designated as the anchor, the average of the features within the ground truth (GT) temporal interval is used as the anchor. Sentence features corresponding to indices within the GT segment are treated as positive pairs, while features outside the GT segment are treated as negative pairs. Conversely, if the sentence feature is selected as the anchor, the average of the sentence features within the GT segment is used as the anchor. In this case, video frame features located within the GT interval are treated as positive pairs, and those outside the interval are treated as negative pairs. The internal cross-modal contrastive loss function is expressed as shown in Equation [4].

$${L}_{cc \_ intra} ( a , x ) = - \frac{1}{B} {{\sum }^{B}}_{i = 1} log \frac{{\sum }_{k ∈ GT} {e}^{( {\overline{a}}_{i}^{T} {x}_{( i , k )} - m ) / τ}}{\begin{matrix}{\sum }_{k ∈ GT} {e}^{( {\overline{a}}_{i}^{T} {x}_{( i , k )} - m ) / τ} + \\ {\sum }_{k ∉ GT} {e}^{( {\overline{a}}_{i}^{T} {x}_{( i , k )} - {\overline{a}}_{i}^{T} {a}_{( i , k )} \cdot {\overline{x}}_{i}^{T} {x}_{( i , k )} ) / τ}\end{matrix}} \qquad [ Equation 4 ]$$

Among the total of K samples in the batch, only the pair with the same index based on the ground truth (GT) is treated as a positive pair, and all other combinations are treated as negative pairs.

Here, aᵢ denotes an anchor with a feature from one modality, and aᵢ, x_{(i,k)} respectively represent frame-level features from the same modality and the opposite modality. (a, x_{(i,k)}) forms a pair. T denotes the transpose operation. In the loss calculation for negative pairs, the average of the inner product aᵢ^{T}·a_{(i,k)} is used, where aᵢ is the anchor and a_{(i,k)} is the negative sample from the same modality. Since aᵢ and a_{(i,k)} have the same vector dimensionality d across all samples, this inner product represents the similarity within the anchor modality if scaling is omitted.

xᵢ^{T}·x_{(i,k)} represents the inner product between xᵢ, which is the feature of the opposite modality corresponding to the anchor, and x_{(i,k)}, which is the feature of the opposite modality corresponding to the negative pair. Since xᵢ and x_{(i,k)} have the same vector dimensionality across all samples, this inner product represents the similarity in the opposite modality corresponding to the anchor if scaling is omitted.

With respect to the similarity between the anchor's modality and the opposite modality feature of a negative pair, which is fundamentally included in the loss function of Cross-modal Contrastive Learning (CCL), the video-level contrastive loss function according to an embodiment of the present invention defines the product of the similarity in the same modality as the anchor and the similarity in the opposite modality corresponding to the anchor as the negative pair margin. The greater this negative pair margin is, the more similar the negative pair is to a positive pair in the same modality. Therefore, the margin is subtracted when aggregating the loss values of negative pairs, thereby reducing the loss value for negative pairs that are similar to positive pairs.

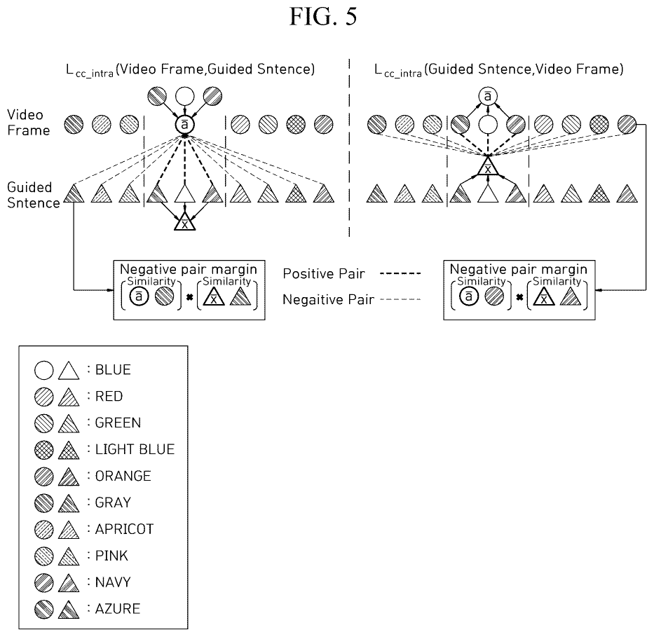

In connection with the loss function for internal Cross-modal Contrastive Learning (CCL) at the frame level, FIG. 5 illustrates frame-level Cross-modal Contrastive Learning (CCL) according to an embodiment of the present invention.

Referring to FIG. 5, the left diagram with respect to the central vertical dashed line illustrates the case where a negative pair margin is computed for a gray natural language query among the negative pair samples (pink, peach, gray, red, green, sky blue, orange, etc.) that fall outside the ground-truth (GT) temporal interval. This is in contrast to the positive pair (blue) consisting of the blue video frame feature used as the anchor and the corresponding natural language query feature at the bottom.

Referring to FIG. 5, the right diagram with respect to the central vertical dashed line illustrates the case where the blue natural language query serves as the anchor, and a video frame outside the GT temporal interval is used as a negative pair sample. In this case, a negative pair margin is computed for the orange negative pair sample on the far right.

The following describes the application of Cross-modal Contrastive Learning (CCL), according to an embodiment of the present invention, to a Temporal Moment Localization (TML) model that utilizes a two-dimensional proposal feature map and a proposal score map.

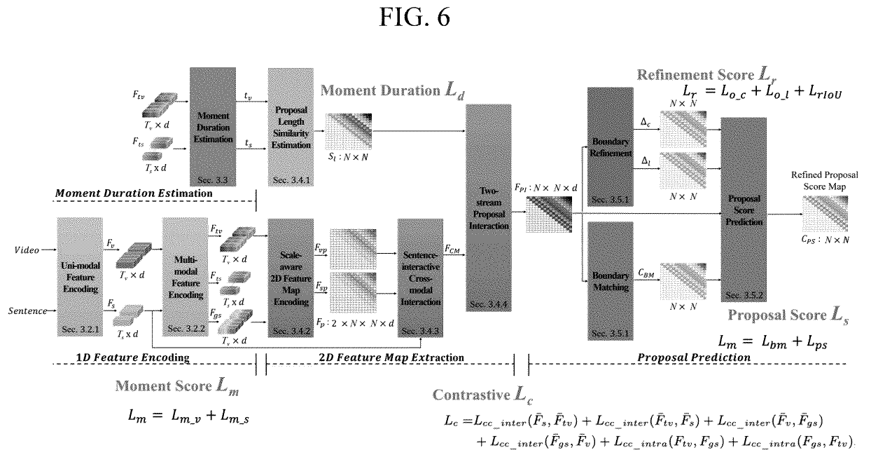

FIG. 6 illustrates a BMRN (Boundary Matching and Refinement Network) for Temporal Moment Localization (TML) based on boundary matching and refinement, according to an embodiment of the present invention.

Referring to FIG. 6, the leftmost blocks (Moment Duration Estimation, Uni-modal Feature Encoding, Multi-modal Feature Encoding) extract one-dimensional video and text features and estimate temporal intervals.

The blocks (Proposal Length Similarity Estimation, Scale-aware 2D Feature Map Encoding, Sentence-interactive Cross-modal Interaction, Two-stream Proposal Interaction) extract a proposal length map and a two-dimensional Proposal Feature Map Extraction.

Using the generated 2D feature map as input, the model predicts a boundary matching map that indicates whether a given proposal matches the boundaries of a semantic segment, as well as refinement maps that adjust the center and length of the proposal to more precisely refine the basic temporal interval represented by the Proposal Feature Map Extraction. Additionally, a final proposal score map is predicted. Based on this set of maps, the model obtains refined proposal segments and selects K proposals that have high scores and do not overlap beyond a predefined threshold. These K proposals are extracted as the top candidate semantic segments in the video that best match the given query.

For the basic loss function used in the BMRN (Boundary Matching and Refinement Network)), the cross-modal contrastive loss function according to an embodiment of the present invention is added to define the overall loss function, as expressed in Equation [5].

$$L = {λ}_{m} \cdot {L}_{m} + {λ}_{d} \cdot {L}_{d} + {λ}_{s} \cdot {λ}_{s} + {λ}_{r} \cdot {L}_{r} + {λ}_{c} \cdot {L}_{c} \qquad [ Equation 5 ]$$

λₖ (where k=m, d, s, r, c) denotes a set of balancing parameters, and Lₘ, Ld, Ls, Lr, and Lc represent the losses corresponding to the video semantic segment score, the segment length, the proposal score, the proposal refinement, and the cross-modal contrastive loss, respectively.

The composition of the cross-modal contrastive loss function is given in Equation [6].

$${L}_{c} = {L}_{cc \_ inter} ( {\overline{F}}_{s} , {\overline{F}}_{tv} ) + {L}_{cc \_ inter} ( {\overline{F}}_{tv} , {\overline{F}}_{s} ) + {L}_{cc \_ inter} ( {\overline{F}}_{v} , {\overline{F}}_{gs} ) + {L}_{cc \_ inter} ( {\overline{F}}_{s} , {\overline{F}}_{tv} ) + {L}_{cc \_ inter} ( {F}_{tv} , {F}_{gs} ) + {L}_{cc \_ inter} ( {F}_{gs} , {F}_{tv} ) \qquad [ Equation 6 ]$$

In Equation [6], the modality cross-contrastive loss function is constructed by combining the video features Fₜᵥ and Fᵥ, and the text features Fₛ and F_{gs}, which are extracted from the BMRN. This combination results in a total of four external video-level contrastive loss functions and two internal frame-level contrastive loss functions.

The balancing parameters (weighting coefficients) for each component loss function that constitutes the total loss function are set as follows: for the Charades-STA benchmark dataset, λₘ=0.5, λ_{d}=1.0, λₛ=0.5, λᵣ=⅓, and λ_{c}= 1/12; and for the ActivityNet Captions dataset, λₘ=0.5, λ_{d}=0.5, λₛ=0.5, λᵣ=⅓, and λ_{c}=0.01. The reason for assigning relatively small values to the balancing parameter of the Cross-modal Contrastive Learning (CCL) component is that the contrastive loss itself is composed of six sub-loss functions internally.

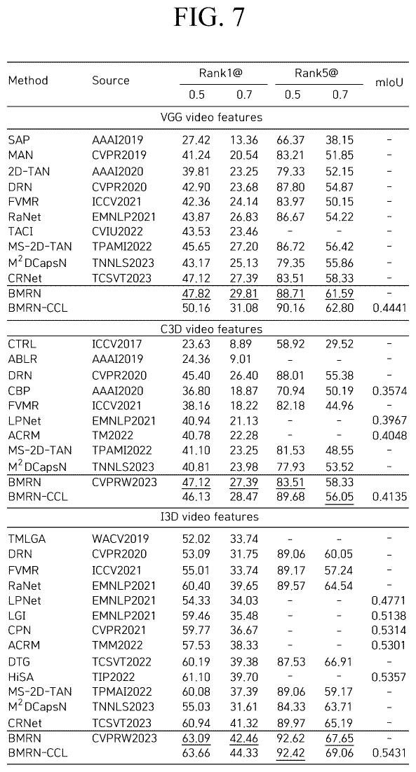

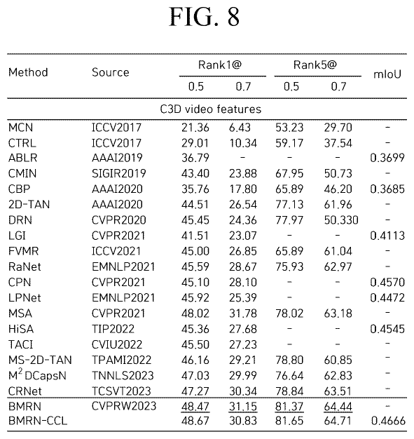

FIG. 7 illustrates the performance comparison results of Temporal Moment Localization (TML) on the Charades-STA dataset, and FIG. 8 illustrates the performance comparison results on the ActivityNet Captions dataset. These figures show the performance comparison results of an embodiment of the present invention on two representative datasets for the Temporal Moment Localization (TML) task: Charades-STA and ActivityNet Captions. As previously described, BMRN-CCL refers to the BMRN model to which the cross-modal contrastive loss function according to an embodiment of the present invention is applied. Referring to FIGS. 7 and 8, it can be confirmed that BMRN-CCL achieves Top-1 performance in most evaluation metrics compared to other models.

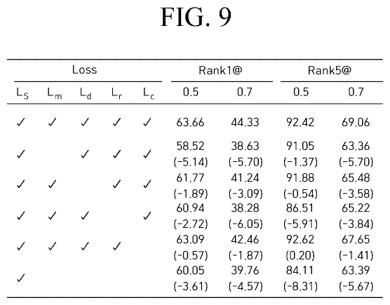

FIG. 9 illustrates the effect of using the cross-modal contrastive loss function. Referring to FIG. 9, it can be observed that, on the Charades-STA dataset, the model trained using all loss functions, including the cross-modal contrastive loss (BMRN-CCL, first row), outperforms the model that excludes only the cross-modal contrastive loss (fifth row), demonstrating a decline in performance. This quantitatively confirms the performance improvement effect of Cross-modal Contrastive Learning (CCL) according to an embodiment of the present invention.

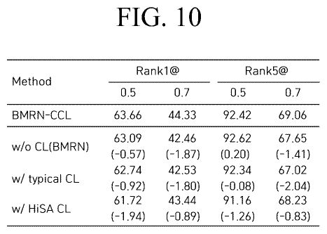

FIG. 10 illustrates a comparison result with models using other contrastive loss functions.

Referring to FIG. 10, the first row represents BMRN-CCL, which applies the Cross-modal Contrastive Learning (CCL) method proposed in the present invention to the BMRN model. The figure compares its performance to that of models trained using conventional contrastive learning techniques and the HiSA method (HiSA: Hierarchically Semantic Associating for Video Temporal Grounding, IEEE Trans. IP, 2022).

Models trained using conventional contrastive learning methods that do not consider similar negative pairs at all, as well as models trained using the HiSA method that partially considers such pairs only at the video level, consistently show inferior performance across all evaluation metrics compared to BMRN-CCL according to the embodiment of the present invention.

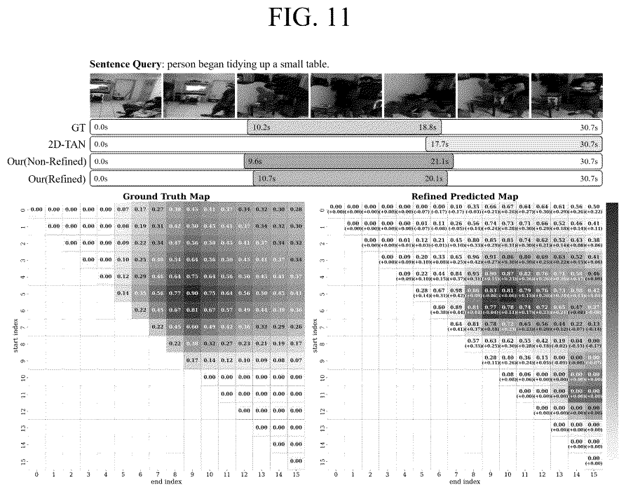

FIG. 11 illustrates the qualitative analysis results of the Temporal Moment Localization (TML) technique based on boundary refinement.

Referring to FIG. 11, it shows qualitative results for natural language queries and corresponding videos from the Charades-STA dataset. Compared to the detection results of 2D-TAN, which uses the same 2D proposal map, the BMRN-CCL model (Our (Refined)) according to an embodiment of the present invention demonstrates more accurate temporal interval detection, achieving results that are closer to the ground truth (GT).

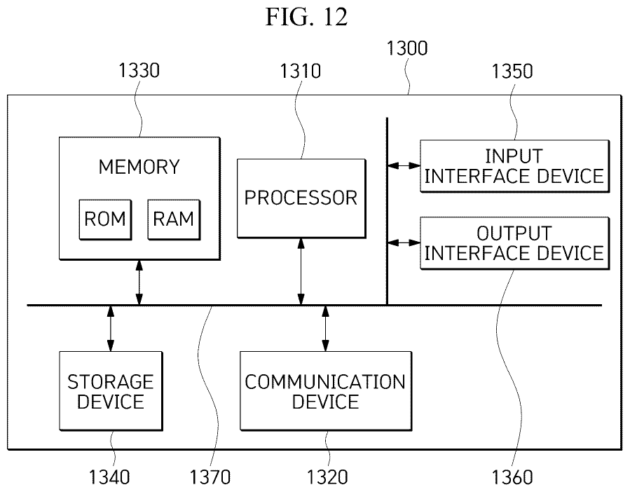

FIG. 12 is a block diagram showing a computer system for implementing the method according to an embodiment of the present invention.

Referring to FIG. 12, the computer system 1300 may include at least one of a processor 1310, a memory 1330, an input interface device 1350, an output interface device 1360, and a storage device 1340, which communicate via a bus 1370. The computer system 1300 may also include a communication device 1320 coupled to a network. The processor 1310 may be a central processing unit (CPU), or a semiconductor device configured to execute instructions stored in the memory 1330 or storage device 1340. The memory 1330 and the storage device 1340 may include various types of volatile or non-volatile storage media. For example, the memory may include read-only memory (ROM) and random access memory (RAM). In an embodiment of the present disclosure, the memory may be located internally or externally to the processor and may be connected to the processor through various known means. The memory, being a volatile or non-volatile storage medium, may include, for example, ROM or RAM.

Accordingly, an embodiment of the present invention may be implemented as a method executed on a computer or as a non-transitory computer-readable medium storing computer-executable instructions. In one embodiment, when executed by the processor, the computer-readable instructions may perform at least one aspect of the method described herein.

The communication device 1320 may transmit or receive wired or wireless signals.

Furthermore, the method according to an embodiment of the present invention may be implemented in the form of program instructions that can be executed through various types of computer means and may be recorded on a computer-readable medium.

The computer-readable medium may include program instructions, data files, data structures, or a combination thereof. The program instructions recorded on the computer-readable medium may be specifically designed and configured for the present invention, or may be known and available to those skilled in the field of computer software. The computer-readable recording medium may include hardware devices configured to store and execute program instructions. For example, the computer-readable recording medium may include magnetic media such as hard disks, floppy disks, and magnetic tapes; optical media such as CD-ROMs and DVDs; magneto-optical media such as floptical disks; and semiconductor memory devices such as ROM, RAM, and flash memory. The program instructions may include not only machine code generated by a compiler but also high-level language code that can be executed by a computer through an interpreter or the like.

While the embodiments of the present invention have been described in detail above, the scope of the present invention is not limited to the foregoing descriptions. Various modifications and variations made by those skilled in the art, utilizing the basic concept defined in the following claims, shall also fall within the scope of the present invention.

What is claimed is:

1. An apparatus for Cross-modal Contrastive Learning (CCL) for Temporal Moment Localization (TML), comprising:
an input interface device configured to receive a video and a query;
a memory storing a program for performing Temporal Moment Localization (TML) to retrieve, from the video, a temporal interval corresponding to the query; and
a processor configured to execute the program,
wherein the processor performs the Temporal Moment Localization (TML) by executing Cross-modal Contrastive Learning (CCL) between linguistic and visual modalities.

2. The apparatus for Cross-modal Contrastive Learning (CCL) for Temporal Moment Localization (TML) according to claim 1,
wherein the query is received from a user device and corresponds to a query described in natural language.

3. The apparatus for Cross-modal Contrastive Learning (CCL) for Temporal Moment Localization (TML) according to claim 1,
wherein the processor performs the Cross-modal Contrastive Learning (CCL) by reducing a loss value of negative pairs that are similar to positive pairs.

4. The apparatus for Cross-modal Contrastive Learning (CCL) for Temporal Moment Localization (TML) according to claim 3,
wherein the processor performs the Temporal Moment Localization (TML) by using an external cross-modal contrastive loss function at the video level.

5. The apparatus for Cross-modal Contrastive Learning (CCL) for Temporal Moment Localization (TML) according to claim 4,
wherein the processor defines the product of the similarity in the same modality as the anchor and the similarity in the opposite modality corresponding to the anchor as a negative pair margin, within a batch composed of video semantic segment and natural language query pairs.

6. The apparatus for Cross-modal Contrastive Learning (CCL) for Temporal Moment Localization (TML) according to claim 4,
wherein the processor subtracts the negative pair margin when aggregating the loss values for negative pairs at the video level.

7. The apparatus for Cross-modal Contrastive Learning (CCL) for Temporal Moment Localization (TML) according to claim 3,
wherein the processor performs the Temporal Moment Localization (TML) by using an internal cross-modal contrastive loss function at the frame level.

8. The apparatus for Cross-modal Contrastive Learning (CCL) for Temporal Moment Localization (TML) according to claim 7,
wherein the processor performs the Temporal Moment Localization (TML) by using features extracted from video frames and sentence features corresponding to each frame, and classifies them into positive pairs within the ground truth (GT) temporal interval and negative pairs outside the GT temporal interval.

9. The apparatus for Cross-modal Contrastive Learning (CCL) for Temporal Moment Localization (TML) according to claim 8,
wherein the processor defines the product of the similarity in the same modality as the anchor and the similarity in the opposite modality corresponding to the anchor as a negative pair margin, using features obtained by average pooling at the corresponding frame of a batch.

10. The apparatus for Cross-modal Contrastive Learning (CCL) for Temporal Moment Localization (TML) according to claim 9,
wherein the processor subtracts the negative pair margin when aggregating the loss values for negative pairs at the frame level.

11. A method for Cross-modal Contrastive Learning (CCL) for Temporal Moment Localization (TML), performed by an apparatus for Cross-modal Contrastive Learning (CCL) for Temporal Moment Localization (TML), the method comprising:
receiving a video and a query; and
performing a task of retrieving, from the video, a temporal interval corresponding to the query,
wherein Cross-modal Contrastive Learning (CCL) is performed at both the video level and the frame level.

12. The method for Cross-modal Contrastive Learning (CCL) for Temporal Moment Localization (TML) according to claim 11,
wherein the step of receiving the video and the query comprises receiving the query corresponding to a query described in natural language.

13. The method for Cross-modal Contrastive Learning (CCL) for Temporal Moment Localization (TML) according to claim 11,
wherein the step of performing the Cross-modal Contrastive Learning (CCL) comprises calculating loss values at both the video level and the frame level based on the similarities between an anchor of a first modality and positive and negative pairs of a second modality different from the first modality.

14. The method for Cross-modal Contrastive Learning (CCL) for Temporal Moment Localization (TML) according to claim 13,
wherein, at the video level, the step of performing the Cross-modal Contrastive Learning (CCL) comprises defining the product of the similarity in the same modality as the anchor and the similarity in the opposite modality corresponding to the anchor, within a batch composed of video semantic segment and natural language query pairs, as a negative pair margin.

15. The method for Cross-modal Contrastive Learning (CCL) for Temporal Moment Localization (TML) according to claim 14,
wherein the step of performing the Cross-modal Contrastive Learning (CCL) comprises subtracting the negative pair margin when aggregating the loss values for negative pairs at the video level.

16. The method for Cross-modal Contrastive Learning (CCL) for Temporal Moment Localization (TML) according to claim 13,
wherein, at the frame level, the step of performing the Cross-modal Contrastive Learning (CCL) comprises using features extracted from video frames and sentence features corresponding to each frame, and performing Temporal Moment Localization (TML) by classifying them into positive pairs within the ground truth (GT) temporal interval and negative pairs outside the GT temporal interval.

17. The method for Cross-modal Contrastive Learning (CCL) for Temporal Moment Localization (TML) according to claim 16,
wherein the step of performing the Cross-modal Contrastive Learning (CCL) comprises defining the product of the similarity in the same modality as the anchor and the similarity in the opposite modality corresponding to the anchor, using features obtained by average pooling at the corresponding frame of the batch, as a negative pair margin.

18. The method for Cross-modal Contrastive Learning (CCL) for Temporal Moment Localization (TML) according to claim 17,
wherein the step of performing the Cross-modal Contrastive Learning (CCL) comprises subtracting the negative pair margin when aggregating the loss values for negative pairs at the frame level.
